(19) United States
(12) Patent Application Publication
(10) Pub. No.: US 2007/0281149 A1
(43) Pub. Date: Dec. 6, 2007

(54) Lithographic apparatus and device manufacturing method

(75) Inventors: Simon Bernardus Cornelis Maria Martens, Waalre (NL); Ronald Harm Gunther Kramer, Reusel (NL)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: ASML NETHERLANDS B.V., Veldhoven (NL)

(21) Appl. No.: 11/447,286

(22) Filed: Jun. 6, 2006

(51) Int. Cl. C09J 5/00

(52) U.S. Cl. 428/336; 156/305

(57) ABSTRACT

The present invention relates to a method of assembling an object that includes providing a first object part having a first surface, providing a second object part having a second surface, positioning the first and the second object parts such that the first and the second surfaces face each other, wherein a gap is defined between the first and the second surfaces, applying a glue to at least a part of the gap, holding the first object part and the second object part at a distance during a period of time, wherein the gap is substantially filled with the glue due to capillary action and/or gravity, and moving the first and the second object parts toward each other to reduce the distance between the first and the second surfaces.

### FIELD OF THE INVENTION

The present invention relates to a lithographic apparatus comprising an object being formed by two or more object parts, a first and a second object part of said two or more object parts being glued together, and a method for making an object comprising gluing a first object part and a second object part to each other.

### DESCRIPTION OF THE RELATED ART

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

During manufacturing of a lithographic apparatus, a number of parts are attached to each other. The present invention in particular relates to the attachment of two parts to each other, whereby at least one of these parts has a low thermal coefficient of expansion (low CTE) such as for instance parts made of Zerodur®, glass, glass ceramics, ULE®, Ohara®, Cordorite®. For the attachment of two of such parts different solutions have been proposed, such as optical contacting, gluing, or using mechanical connection means such as bolts and nuts. Some considerations in using a particular method to attach these parts to each other are (manufacturing) costs and weight. Especially for movable parts which can be moved quickly and with high accuracy, such as a reticle stage or a substrate stage as used in a lithographic apparatus, weight is a factor. For such applications, the use of mechanical connection means is not typically preferred, as such connection means typically introduce extra weight.

As an alternative, “optical contacting” of two parts may be applied; i.e. establishing a bond via molecular attraction between two surfaces. In order for this to work, the surfaces to be bonded should fit closely to each other (on sub-micron level). After being polished and being made completely free of dust, grease and other impurities, the surfaces may bond due to molecular attraction. With optical contacting, a very strong bond can be obtained between two parts resulting in a substantially monolithic behavior of such two-part object. Such monolithic behavior may be advantageous, as the attachment of the two parts does not introduce any additional flexibility in the object in comparison with a similar object being made of a single part.

A possible drawback of the “optical contacting” method is that a considerable effort is typically made in preparing the surfaces in order to make optical contacting possible. This may make the method expensive and time consuming. A further possible drawback of optical contacting is that it may be difficult to adjust the alignment of the parts once they have become bonded.

Another alternative for the use of conventional connection means is the use of glue to attach two separate parts of an object to each other. An example of a glue connection in the known lithographic apparatus is an encoder grid scale attached to a reticle stage body via glue. Such encoder grid scale is used to determine the position of the reticle stage with the use of an encoder sensor system. Such encoder system as such is known in the art. The glue is applied in a number of dots in a predetermined pattern on one of the encoder grid scale and the reticle stage body. Subsequently, the encoder grid scale and reticle stage body are brought together and the glue is cured.

A possible drawback of the known gluing method is that this method is sensitive to the amount of glue per dot, the pattern of the glue dots, and the type of glue. The main goal in the application of the glue is to minimize stress in the glue as a result of shrinkage after curing of the glue. Stress may cause creep of the glue and therefore deformation (bending) of the encoder grid scale. Such deformation may lead to incorrect position measurement and therefore poor product quality, for instance caused by overlay failures.

Due to the relevant factors of the glue procedure, this process is typically only performed with the desired accuracy when use is made of an automated process involving glue robots and automated dose measuring devices, but still the procedure is sensitive to errors and may easily lead to stress in the glue connection between the object parts of the resulting object.

A further possible drawback of the known gluing method is that the resulting glue connections may be sensitive to the influence of moisture. When, for instance the reticle stage of the above example is moved between areas with different humidity, creep may occur due to the influence of moisture on the glue. Typically, the glue connection is made in a clean room environment, while the reticle stage is used in a micro environment in which clean dry air is used. As a result of the difference in humidity in these two environments, overlay failures may occur in the measurement of the position of the reticle stage, as the scale drifts caused by shrinkage/expansion of the glue due to moisture being vapoured out or absorbed by the glue. Such failures in overlay, or other negative influences on product quality are undesirable.

A further possible drawback of the known gluing method is that the glue connection may provide additional flexibility between the two object parts, resulting in non-monolithic behavior of the object. Such non-monolithic behavior may lead to internal deformations resulting in measurement errors and longer control settling times during positioning of the object.

### SUMMARY

It is desirable to provide a method for gluing two parts of an object to each other, wherein said method is less sensitive to errors in relation to the appliance of the glue, i.e. position and/or quantity.

Furthermore, it is desirable to provide an object being formed by gluing a first object part and a second object part together, wherein one or more of the above-mentioned drawbacks of the known gluing method are substantially reduced or taken away. In particular, it is desirable to provide a lithographic apparatus having an object being formed by gluing a first object part and a second object part together, wherein the glue connection is less sensitive to moisture, as compared to the known method.

According to an embodiment of the invention, there is provided a method of assembling an object, comprising: providing a first object part having a first surface, providing a second object part having a second surface, positioning said first and said second object parts such that the first and the second surfaces face each other, wherein a gap is defined between said first and said second surfaces, applying a glue to at least a part of said gap, holding said first object part and said second object part at a distance during a period of time, wherein said gap is substantially filled with said glue due to capillary action and/or gravity, and moving said first and said second object parts toward each other to reduce the distance between said first and said second surfaces.

According to an embodiment of the invention, there is provided an object comprising a first object part and a second object part, said first and second object parts being made of a material having a low thermal expansion coefficient and being connected to each other at a first surface of said first object part and at a second surface of said second object part via a film of glue that substantially covers said first and/or said second surface, said film of glue having a thickness of 1-8 μm.

According to an embodiment of the invention, there is provided a measurement system configured to measure a position quantity of a movable object, said measurement system comprising: a first component mountable on a substantially stationary frame, and a second component, a first surface of said movable object being connected to a second surface of said second component via a film of glue that substantially covers said first and/or said second surface, said film of glue having a thickness of 1-8 μm.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2a and 2b depict a top view and a side view of an encoder grid scale glued to a reticle chuck body according to prior art;

FIGS. 3a and 3b depict a top view and a side view of an encoder grid scale glued to a reticle chuck body according to an embodiment of the present invention; and

FIGS. 4a-4d depict four steps of a method to glue a first object part to a second object part according to the invention.

### DETAILED DESCRIPTION

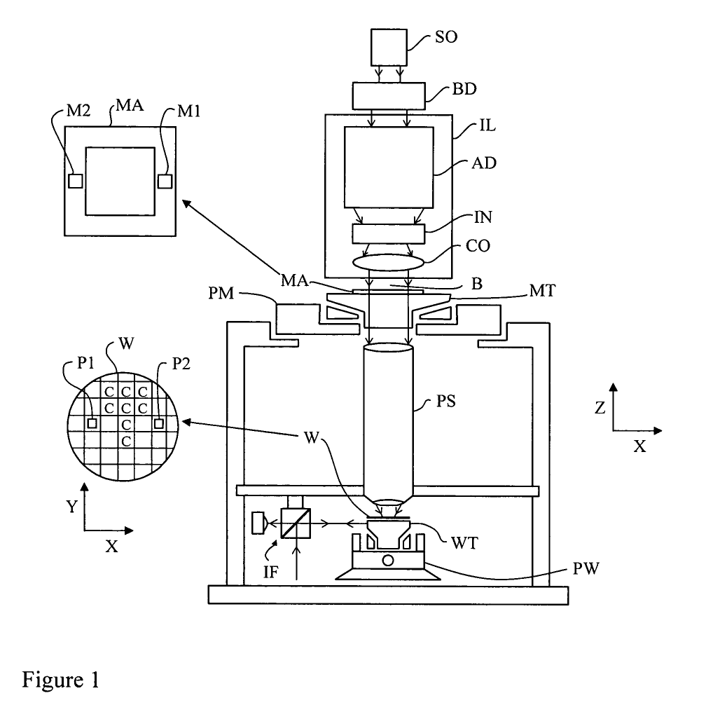

FIG. 1 schematically depicts a lithographic apparatus according to one embodiment of the invention. The apparatus includes an illumination system (illuminator) IL configured to condition a radiation beam B (e.g. UV radiation or any other suitable radiation), a mask support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The mask support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The mask support structure can use mechanical, vacuum, electrostatic or other clamping techniques to hold the patterning device. The mask support structure may be a frame or a table, for example, which may be fixed or movable as required. The mask support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the mask support structure (e.g., mask table MT), and is patterned by the patterning device. Having traversed the mask MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the mask table MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the mask table MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

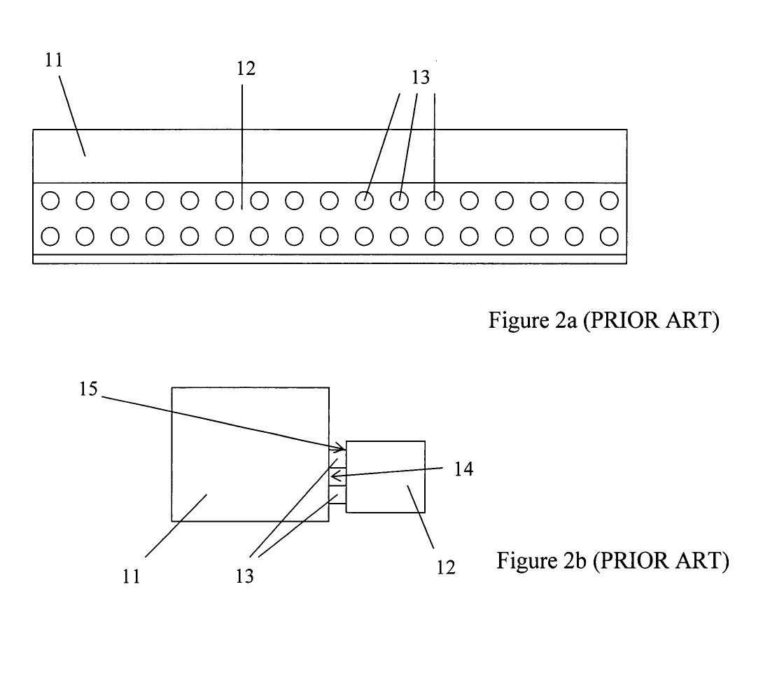

FIGS. 2a and 2b depict a reticle chuck body 11 and an encoder grid scale 12 being attached to each other via a glue connection. The reticle chuck body 11 and the encoder grid scale 12 may be part of a reticle stage, as depicted in FIG. 1. In the shown embodiment, the reticle chuck body 11 is designed to carry a reticle. The reticle chuck body 11 may further comprise or be attached to actuator parts and parts of measurement systems, such as the encoder grid scale 12. Both the reticle chuck body 11 and the encoder grid scale 12 are made of a material which has a low thermal coefficient of expansion (low CTE), such as Zerodur®, glass, glass ceramics, ULE®, Ohara®, Cordorite® or the like.

The encoder grid scale 12 comprises a scale which can be read by an encoder sensor being mounted on a relative stationary frame, such as for instance the metro frame. With such encoder system the position of the reticle can be determined with a high accuracy (nanometer accuracy). Typically the encoder system is capable of determining the position of the reticle stage in x, y and Rz. To ensure that the encoder system does not incorrectly determine the position of the reticle, the position of the encoder grid scale should not be influenced by any environmental conditions such as temperature and humidity of the ambient atmosphere. Also, the position of the encoder grid scale 12 with respect to the reticle chuck body 11 should preferably not be influenced by the acceleration of the reticle chuck body, i.e. the assembly of the reticle chuck body 11 and the encoder grid scale 12 should behave as if it were a monolithic body which does not deform due to accelerations.

The encoder grid scale 12 is glued with a number of glue dots 13 to the reticle chuck body 11. To make such a glue connection, dots of glue are arranged on a glue surface 14 of the reticle chuck body 11 or a glue surface 15 of the encoder grid scale 12 in a predetermined pattern, subsequently the glue surfaces 14, 15 of the reticle chuck body 11 and the encoder grid scale 12, respectively, are positioned with respect to each other defining a glue gap between them, therewith defining a glue layer thickness. The thickness of such layer is typically 10 μm. A glue typically used in the known method is for instance a universal two component epoxy manufactured by Huntsman (Salt Lake City, Utah, USA) under the name Araldite 2011®.

In order to minimize creep of the glue after curing, which may result in deformation of the encoder grid scale 12, the stress in the dots of glue 13 should be kept as low as possible. To minimize stress in the dots of glue 13, the dots of glue 13 have to be arranged during the gluing process on the reticle chuck body 11 or encoder grid scale 12 with high accuracy with respect to both the amount of glue per dot and the position where such glue dot 13 is arranged. To ensure that this is performed with the desired accuracy, use is made of automated process devices such as robots for applying the glue dots 13 in the desired pattern and dose measuring devices to determine that the correct amount of glue is used for a single dot of glue 13.

The prior art glue connection using a pattern of dots of glue 13 is relatively sensitive to moisture. As a result, the object that is formed of at least two object parts being glued together may be influenced by moving the object between different environmental circumstances. For instance the encoder grid scale 12 may be glued to the reticle chuck body 11 in a clean room environment and, thereafter, be used in a micro-environment having clean dry air. The (relative) lack of moisture in the latter environment may lead to moisture vapouring out of the glue, and, as a consequence, shrinkage of the glue which may result in deformation of the encoder grid scale 12 with respect to the reticle chuck body 11. Such deformation of the encoder grid scale 12 may lead to incorrect position measurement of the reticle stage and thus for instance overlay errors during use of the lithographic apparatus.

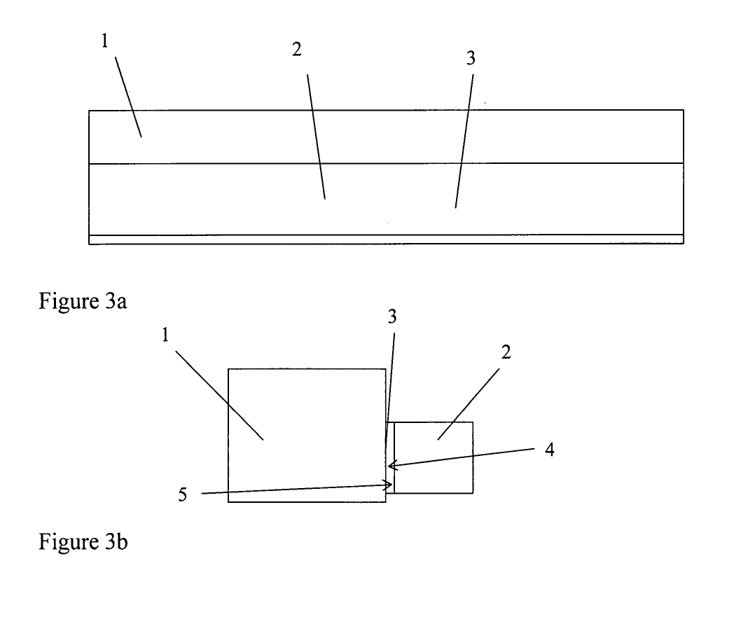

In FIGS. 3a and 3b an embodiment of the present invention is shown. In this embodiment the reticle chuck body 1 and the encoder grid scale 2 are glued together via a continuous layer of glue 3. By providing a continuous layer of glue 3 instead of a number of glue dots in a predefined pattern, the ratio between the outline of the glue (length of the edge of glue) versus the surface area of the glue has become significantly smaller. This may reduce the amount of moisture that vapors out of the glue during a certain time period, as compared to the amount of moisture that vapors out of the glue dots according to the known method, as there is a relatively smaller part of the glue that is directly into contact with the environment. In this context, a continuous glue layer means that the glue layer substantially extends over the complete surface area of the glue surface 4 of the reticle chuck body 1 or the glue surface 5 of the encoder grid scale 2.

To further decrease the influence of moisture on deformation of the encoder grid scale 2, the thickness of the glue layer is smaller than the prior art layer. The glue layer is preferably 1-8 μm, more preferably 2-6 μm, and even more preferably 2-4 μm. The thickness of the glue layer in the embodiment shown in FIGS. 3a and 3b is about 3 μm. This means that the glue gap being the distance between the glue surfaces 4 and 5 has a width of 3 μm. By decreasing the width of the glue gap, there will be less moisture present in the glue as the total amount of glue is smaller. An advantage of a smaller thickness of the glue layer 3 is that the shrinkage of the glue layer 3 which will occur due to moisture vapouring out of the glue layer is relatively small, resulting in less deformation of the encoder grid scale 2 and thus a lower chance on incorrect position measurement. Also, it has been found that the more the thickness of the layer of glue 3 can be reduced, the more the assembled object will behave as a monolithic object.

A very suitable epoxy resin to be used as a glue is an epoxy resin selected from the group consisting of Bisphenol A and Bisphenol F families, as these epoxy resins are relative less sensitive for moisture. In particular, an epoxy manufactured by Epoxy Technology, (Billerica, Mass., USA), named Epo-tek 302-3M® has shown to be very suitable due to the low moisture sensitivity and good capillary action. The advantage of the latter characteristic will be discussed later. Thus, the use of such epoxy resin may reduce the chance of deformations in the encoder grid scale 2 caused by the influence of moisture in the glue and/or direct environment.

In the embodiment of FIGS. 3a and 3b the reticle chuck body 1 and the encoder grid scale 2 are attached to each other with a single continuous layer of glue. This may result in better performance of the glue connection between the respective object parts 1 and 2. However, when such single layer is applied with the prior art process as discussed in relation to the prior art embodiment of FIGS. 2a and 2b, the inclusion of air bubbles in the glue layer is very likely. Such inclusion of air bubbles is highly undesired, as these may cause weak spots in the glue connection.

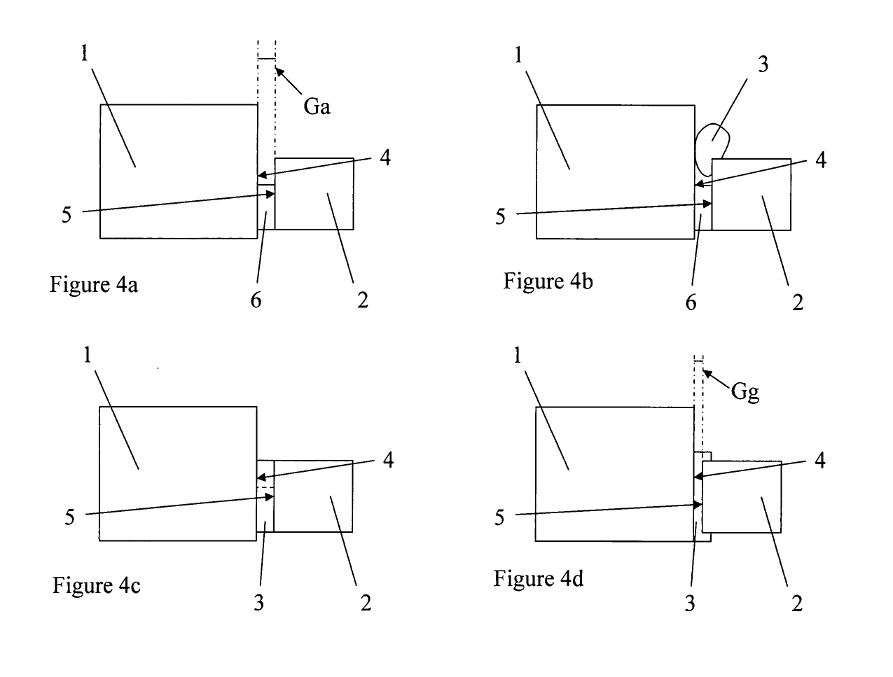

As an alternative, it is possible to make use of capillary action and/or gravity to let enter the glue in a gap between the object parts. In this alternative, the chance on inclusions of air bubbles becomes considerably lower. However, the smaller width of the glue gap, as proposed in embodiments of the present invention, makes such use of capillary action and/or gravity with the desired epoxy resins practically impossible as the width of the glue gap is too small. A method according to embodiments of the invention to obtain the embodiment of FIGS. 3a and 3b will be explained hereinafter in relation to FIGS. 4a-4d.

In FIGS. 4a to 4d four moments during the gluing method according to the invention are shown. The different steps that are taken in order to glue a first object part to a second object part. In particular, gluing an encoder grid scale 2 to a reticle chuck body 1 will be discussed.

In FIG. 4a the reticle chuck body 1 and the encoder grid scale 2 are shown before any glue is applied on one of them. A glue surface 4 of the reticle chuck body 1 is placed opposite a glue surface 5 of the encoder grid scale 2. The distance Ga between the glue surfaces 4 and 5 is approximately 20 μm. This distance defines a glue appliance gap having a width corresponding to this distance. Depending on circumstances such as height of the glue surfaces 4 and 5 and the type of glue/epoxy resin used the width of the glue appliance gap may vary. The glue appliance gap is preferably at least 10 μm, preferably 15-25 μm. The width of the glue appliance gap Ga is chosen to make the entering of glue into the glue appliance gap as a result of capillary action and/or gravity possible.

In order to position and maintain the glue surfaces 4 and 5 at the desired distance, spacers 6 may be placed between the two glue surfaces 4 and 5. Any other suitable means or method for positioning the glue surfaces 4 and 5 and maintaining the desired distance between the two glue surfaces 4 and 5 may also be used.

In FIG. 4b a certain amount of glue is applied on top of the glue appliance gap. The glue will enter the glue appliance gap by capillary action and/or gravity. As the glue will relatively slowly enter the gap from one side, the chance on air inclusions is very small. As the glue is applied at substantially the whole top edge of the glue appliance gap, the glue will enter as a substantially continuous layer into the gap (except for the location of the spacers 6). After the glue is applied, a certain amount of time has to elapse in order to make sure that the glue occupies substantially the whole glue appliance gap by capillary action and/or gravity. In the case where for instance the encoder grid scale 2 is transparent, it can easily be seen when the glue appliance gap is substantially filled. The amount of time that has to elapse in order to fill the glue appliance gap depends on a number of parameters such as the glue that is used, in particular the viscosity of the glue and/or the capillary action of the glue, the width of the glue appliance gap, etc. In any case, the amount of time may not be longer than the open time of the glue, i.e. the time during which the glue is fluid. In the present example this time is 8 to 12 minutes.

In FIG. 4c the glue appliance gap Ga is substantially filled with glue with the exception of the position of the spacers (shown in dashed lines). After the spacers 6 are removed, the remaining space may, if needed, be filled with glue.

After that the spacers (when present) have been removed, the reticle chuck body 1 and the encoder grid scale are moved towards each other so that the glue surfaces 4 and 5 become arranged at a distance Gg (see FIG. 4d) that is substantially smaller than the width of the glue appliance gap Ga. This distance Gg is in the illustrated embodiment about 3 μm. In general the distance that substantially corresponds with the thickness of the resulting glue layer is preferably 1-8 μm, more preferably 2-6 μm, and even more preferably 2-4 μm. The two object parts may then be pressed towards each other for a certain amount of time, for instance 20-28 hours, in order to obtain the two object parts being glued together with the desired glue gap therebetween. The distance Gg is preferably chosen as small as possible, without the two object parts directly touching each other.

In FIG. 4d the reticle chuck body 1 and the encoder grid scale 2 are shown after moving these object parts towards each other. It can be seen that a certain quantity of glue has come out of the glue gap Gg as the volume between the two glue surfaces 4 and 5 has decreased. In this way, the glue layer 3 may completely extend over the glue surfaces 4 and 5 as a continuous single layer. The excess glue may be removed when desired. As an alternative, the amount of glue arranged on top of the glue appliance gap may be less so that there is no or a reduced amount of excessive glue. The excessive glue may also be used to fill the remaining space after removal of the spacers, so that no separate filling of these spaces is necessary. After curing of the glue, the gluing process has been completed.

In general it can be concluded that the method according to the invention is less sensitive than conventional methods, as use is made of capillary action and/or gravity to apply the glue to one or both object parts. Furthermore, as one continuous layer of glue is used, the amount of glue applied is less sensitive and no difficult patterns have to be made. Therefore the method may be performed manually, so that no use has to be made of expensive automated equipment.

In the above description an example was given of two object parts which can be glued together to form one object. The present invention may be used to connect two object parts of any object in which moisture sensitivity is of importance, and/or in which nanometer stability of the resulting assembly is desired in view of environmental conditions such as humidity. All such embodiments are deemed to fall within the scope of the invention. An example of such object may be a mirror being connected to a projection optics box in a lithographic apparatus. In particular, the invention may be suitable to connect a component of a measurement system to a movable object, such as a reticle stage or wafer stage. The measurement system may be configured to measure any position quantity. In this context a position quantity may be any signal representative for a position of said movable object or a derivative thereof. Thus, such position quantity may comprise a position, speed or acceleration of said movable object, as well as combinations or equivalents thereof.

It is remarked that it is possible that a resulting object comprises more than two parts and that only some of these parts are attached to each other via a glue layer according to the present invention.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method of assembling an object, comprising:
providing a first object part having a first surface,
providing a second object part having a second surface,
positioning said first and said second object parts such that the first and the second surfaces face each other, wherein a gap is defined between said first and said second surfaces,
applying a glue to at least a part of said gap,
holding said first object part and said second object part at a distance during a period of time, wherein said gap is substantially filled with said glue due to capillary action and/or gravity, and
reducing the distance between said first and said second surfaces after said glue is applied to said gap.

2. The method of claim 1, wherein said first and/or said second object part is made of a material having a low thermal expansion coefficient.

3. The method of claim 1, wherein said gap has a width of at least 10 μm.

4. The method of claim 3, wherein said gap has a width of 15-25 μm.

5. The method of claim 1, wherein a resulting distance after reducing the distance between said first and said second surfaces moving said first and said second surfaces is 1-8 μm.

6. The method of claim 5, wherein the resulting distance is 2-6 μm.

7. The method of claim 1, wherein a spacer is spacers used to position and maintain said first surface and second surface at said distance.

8. The method of claim 7, wherein said spacer is removed before reducing the distance between said first and said second surfaces, and the remaining space is filled with glue after removal of said spacers.

9. The method of claim 1, wherein a continuous film of glue is applied between said first surface and said second surface.

10. The method of claim 1, wherein said first object part is a movable object and said second object part is a part of a measurement system configured to measure a position quantity of said movable object.

11. A method for providing a measurement system configured to measure a position quantity of a movable object, said method comprising
mounting a first component of said measurement system on a substantially stationary frame, and
connecting a second component of said measurement system on said movable object by:
positioning said movable object and said second component such that a first surface of the movable object and a second surface of the second component face each other, wherein a gap is defined between said first and said second surfaces,
applying a glue to at least a part of said gap,
holding said movable object and said second component at a distance during a period of time, wherein said gap is substantially filled with said glue due to capillary action and/or gravity, and
reducing the distance between said first and said second surfaces after said glue is applied to said gap.

12. The method of claim 11, wherein said movable object is one of a reticle chuck body or a wafer chuck body.

13. The method of claim 11, wherein said measurement system is an encoder measurement system, said first component being an encoder head and said second component being an encoder grid scale.

14. A method for manufacturing a reticle stage or a wafer stage, said reticle stage or wafer stage comprising a first object part and a second object part being connected to each other by:
positioning said first and said second object parts such that a first surface of the first object part and a second surface of the second object part face each other, wherein a gap is defined between said first and said second surfaces,
applying a glue to at least a part of said gap,
holding said first object part and said second object part at a distance during a period of time, wherein said gap is substantially filled with said glue due to capillary action and/or gravity, and
reducing the distance between said first and said second surfaces after said glue is applied to said gap.

15. The method of claim 14, wherein said first object part comprises a bottom part of said reticle stage and said second object part comprises a top part of said reticle stage.

16. A method for manufacturing a reticle stage or a wafer stage, comprising the step of connecting a component of a measurement system on a reticle stage body or a wafer stage body, respectively, by:
positioning said reticle stage body or wafer stage body and said component such that a first surface of the reticle stage body or wafer stage body and a second surface of the component face each other, wherein a gap is defined between said first and said second surfaces,
applying a glue to at least a part of said gap,
holding said reticle stage body or wafer stage body and said component at a distance during a period of time, wherein said gap is substantially filled with said glue due to capillary action and/or gravity, and
reducing the distance between said first and said second surfaces after said glue is applied to said gap.

17. An object comprising a first object part and a second object part, said first and second object parts being made of a material having a low thermal expansion coefficient and being connected to each other at a first surface of said first object part and at a second surface of said second object part via a film of glue that substantially covers said first and/or said second surface, said film of glue having a thickness of 1-8 μm.

18. The object of claim 17, wherein said film of glue has a thickness of 2-6 μm.

19. The object of claim 18, wherein said film of glue has a thickness of 2-4 μm.

20. The object of claim 17, wherein said first object part and said second object part are only attached to each other via said film of glue.

21. The object of claim 17, wherein said glue film completely extends over the surface area of said first and said second surfaces.

22. The object of claim 17, wherein said glue is an epoxy resin selected from the group consisting of Bisphenol A and Bisphenol F families.

23. A measurement system configured to measure a position quantity of a movable object, said measurement system comprising:
a first component mountable on a substantially stationary frame, and
a second component, a first surface of said movable object being connected to a second surface of said second component via a film of glue that substantially covers said first and/or said second surface, said film of glue having a thickness of 1-8 μm.

24. The measurement system of claim 23, wherein said second component and/or movable object are, at least partially, made of a material having a low thermal expansion coefficient.

25. The measurement system of claim 23, wherein said first component is an encoder head and said second component is an encoder grid scale.

26. The measurement system of claim 23, wherein said film of glue has a thickness of 2-6 μm.

27. The measurement system of claim 26, wherein said film of glue has a thickness of 2-4 μm.

28. The measurement system of claim 23, wherein said movable object and said second component are only attached to each other via said film of glue.

29. The measurement system of claim 23, wherein said continuous glue film completely extends over the surface area of said first and said second surfaces.

30. The measurement system of claim 23, wherein said glue is an epoxy resin selected from the group consisting of Bisphenol A and Bisphenol F families.

31. A lithographic apparatus comprising
a substrate table configured to hold a substrate;
a system configured to transfer a pattern to the substrate; and
a measurement system configured to measure a position quantity of a movable object, said measurement system comprising:
a first component mountable on a substantially stationary frame, and
a second component, a first surface of said movable object being connected to a second surface of said second component via a film of glue that substantially covers said first and/or said second surface, said film of glue having a thickness of 1-8 μm.

32. A manufacturing method comprising measuring a position quantity of a movable object using a measurement system configured to measure a position quantity of a movable object, said measurement system comprising a first component mountable on a substantially stationary frame, and a second component, a first surface of said movable object being connected to a second surface of said second component via a film of glue that substantially covers said first and/or said second surface, said film of glue having a thickness of 1-8 μm.
